(19) United States
(12) Patent Application Publication
(10) Pub. No.: US 2026/0245012 A1
(43) Pub. Date: Aug. 20, 2026

(54) SYSTEMS AND METHODS FOR OPTIMIZING ASSET MANAGEMENT IN A PLANT

(71) Applicant: Honeywell International Inc., Charlotte, NC (US)

(72) Inventors: Joseph Lu, Glendale, AZ (US); Viraj Srivastava, Bangalore (IN); Sanjay Dave, Reading (GB); Murugesh Palanisamy, Bangalore (IN)

(21) Appl. No.: 19/054,926

(22) Filed: Feb. 17, 2025

(51) Int. Cl. G06Q 10/0631

(52) U.S. Cl. CPC G06Q 10/06315

(57) ABSTRACT

Various embodiments described herein relate to systems and methods for optimizing asset management in a plant. In this regard, the impact value data for an intermediate physical stream in the plant is determined such that the impact value data is associated with profitability of the plant. Then, predictions for one or more assets in the plant are provided such that at least one prediction is related to an anomaly of an asset. Further, impact of the predictions on the profitability of the plant is assessed using the impact value data. Based on the assessment, the predictions are prioritized. For each of the prioritized predictions, suitable recommendations are generated. Also, the generated recommendations are rendered via a user interface.

### TECHNICAL FIELD

The present disclosure generally relates to management of assets in a facility. More particularly, the present disclosure relates to optimizing asset management in a plant.

### BACKGROUND

Generally, a plant (such as an industrial plant, a manufacturing unit, a processing factory, and/or the like) includes numerous assets or equipment such as boilers, chillers, pumps, sensors, air handling units (AHUs), variable refrigerant flow (VRF) systems, blenders, furnaces, and/or the like. Often these assets are employed to facilitate various processes in the plant. For instance, a specific set of assets may operate to facilitate certain processes such as blending operations to produce say, petroleum products from crude oil. Accordingly, numerous such processes are undertaken on a day-to-day basis using the assets employed in the plant. Given that the number of assets along with the processes undertaken are quite substantial, manually managing all of the assets and the processes by personnel associated with the plant becomes an error-prone chore and a challenging task. So, the plant often opts asset management solutions available in the market to automate significant aspects related to management of assets in the plant. In this regard, such traditional asset management solutions analyze data related to an asset of the assets in the plant and provide appropriate suggestions for that asset. More particularly, the said traditional asset management solutions include objectives defined on an individual asset basis. That is, the objectives are commonly defined for a particular asset and are narrowly applicable only for that particular asset. This approach can be limiting, as traditional solutions fail to consider whether the assets to be maintained contribute to processing bottlenecks that restrict the plant's ability to make more profit. As a result, such solutions are often incapable of identifying which assets require maintenance to alleviate bottlenecks and enhance profit margins. Instead, their recommendations frequently incur significant costs without seeking any maintenance opportunities to increase profitability by resolving critical processing bottlenecks.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing an exemplary environment comprising multiple plants, in accordance with one or more example embodiments described herein.

FIG. 2 illustrates a schematic diagram showing an implementation of a controller that may execute techniques in accordance with one or more example embodiments described herein.

FIG. 3 illustrates a schematic diagram showing an implementation of an exemplary asset management system, in accordance with one or more example embodiments described herein.

FIG. 4 illustrates a schematic diagram showing an exemplary flow sheet model, in accordance with one or more example embodiments described herein.

FIG. 5 illustrates a schematic diagram showing an exemplary user interface associated with an exemplary asset management system, in accordance with one or more example embodiments described herein.

FIG. 6 illustrates a schematic diagram showing an exemplary user interface associated with an exemplary asset management system, in accordance with one or more example embodiments described herein.

FIG. 7 illustrates a schematic diagram showing an exemplary use case associated with an exemplary asset management system, in accordance with one or more example embodiments described herein.

FIG. 8 illustrates a flowchart showing a method described in accordance with one or more example embodiments described herein.

FIG. 9 illustrates a flowchart showing a method described in accordance with one or more example embodiments described herein.

FIG. 10 illustrates a flowchart showing a method described in accordance with one or more example embodiments described herein.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with one or more example embodiments of the current disclosure, a method for optimizing asset management in a plant is described herein. In this regard, the method comprises determining impact value data for an intermediate physical stream of a plurality of physical streams of the plant. It is to be noted that the impact value data is associated with profitability of the plant. Further, the method comprises providing a plurality of predictions for one or more assets from a plurality of assets in the plant such that at least one prediction is related to an anomaly of an asset of the one or more assets. Furthermore, the method comprises assessing impact of each of the plurality of predictions on the profitability of the plant based at least on the impact value data. Then, the method comprises prioritizing one or more predictions from the plurality of predictions based on the impact assessed for each of the plurality of predictions. Also, the method comprises generating one or more recommendations for each of the one or more prioritized predictions. Additionally, the method comprises rendering, via a user interface, the one or more recommendations generated for each of the one or more prioritized predictions.

In accordance with another embodiment of the current disclosure, a system for optimizing asset management in a plant is described herein. The system comprises a processor and a memory communicatively coupled to the processor, wherein the memory comprises one or more instructions which when executed by the processor, cause the processor to determine impact value data for an intermediate physical stream of a plurality of physical streams of the plant. It is to be noted that the impact value data is associated with profitability of the plant. The processor is also configured to provide a plurality of predictions for one or more assets from a plurality of assets in the plant such that at least one prediction is related to an anomaly of an asset of the one or more assets. Also, the processor is configured to assess impact of each of the plurality of predictions on the profitability of the plant based at least on the impact value data. Then, the processor is also configured to prioritize one or more predictions from the plurality of predictions based on the impact assessed for each of the plurality of predictions. Further, the processor is configured to generate one or more recommendations for each of the one or more prioritized predictions. Furthermore, the processor is configured to render, via a user interface, the one or more recommendations generated for each of the one or more prioritized predictions.

In accordance with yet another embodiment of the current disclosure, a non-transitory, computer-readable storage medium having instructions stored thereon and executable by one or more processors is described herein. In this regard, the instructions when executed by one or more processors cause the one or more processors to determine impact value data for an intermediate physical stream of a plurality of physical streams of the plant. It is to be noted that the impact value data is associated with profitability of the plant. The one or more processors are also configured to provide a plurality of predictions for one or more assets from a plurality of assets in the plant such that at least one prediction is related to an anomaly of an asset of the one or more assets. Also, the one or more processors are configured to assess impact of each of the plurality of predictions on the profitability of the plant based at least on the impact value data. Then, the one or more processors are also configured to prioritize one or more predictions from the plurality of predictions based on the impact assessed for each of the plurality of predictions. Further, the one or more processors are configured to generate one or more recommendations for each of the one or more prioritized predictions. Furthermore, the one or more processors are also configured to render, via a user interface, the one or more recommendations generated for each of the one or more prioritized predictions.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one example embodiment of the present disclosure, and can be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some example embodiments, or it can be excluded.

More particularly, asset management solutions available in the market are being mostly relied on for managing wide variety of assets in a plant. Traditionally, such solutions consider operating conditions such as temperature, operating performance, flow rate, vibrations, and/or the like associated with the assets to determine if corresponding assets are operating normally or abnormally. If operations of certain assets are determined to be abnormal or anomalous, traditional asset management solutions determine appropriate suggestions to correct those assets detected as abnormal or anomalous. Mostly, such suggestions correspond to corrective actions which can be undertaken by personnel such as operators in the plant so as to make such abnormal or anomalous assets operate back as normal. Provided that the traditional asset management solutions merely consider certain operating conditions, most of the suggestions may be ineffective from an economical perspective. Also, traditionally such solutions are often configured to maintain operations of the assets at their best or normal performance. In this regard, the traditional asset management solutions often expect the assets to primarily operate at their best or normal performance. So, when performance of such managed assets slightly drops or marginally deviates from its respective expected performance, the said traditional solutions often propose suggestions for corresponding assets. Though the suggestions may facilitate the assets to operate back at their best or normal performance, some of these suggestions may not be economically viable to the plant. More particularly, only few assets in the plant have an impact on profitability of the plant. That is, only about 3-5% of the total assets in the plant play a crucial role and have an impact on the plant profitability. So, these suggestions may create situations where certain actions may be undertaken for those assets that do not have a positive economic impact on the profitability of the plant as well leading to negative impact on the overall economy of the plant. However, at the same time, selectively identifying such assets that have significant impact on the plant profitability also becomes a tough task.

Firstly, most of the suggestions are tailored to address issues related to only that specific asset without considering interrelationships between the assets and/or processes of related assets. For example, several streams in a processing plant may involve corresponding assets to produce related products. However, a particular asset in one of the streams may be faulty and a suggestion may correspond to shutting down of the processing plant and replacing specific components of that particular asset so as to correct fault(s). Though such an action may correct the fault(s) of that particular asset, this may negatively impact other related assets (which are upstream or downstream to that particular asset) or processes which may be involved in producing a product which is of higher economic importance. So, such specific actions undertaken for a particular asset may negatively impact other interrelated assets and the plant too as constraints on a single asset have a global impact (that is, at plant level). Also, with such specific suggestions, asset management becomes a localized activity and lacks global thinking (that is, at plant level) from economic perspective. Secondly, the said traditional solutions do not consider economical aspects related to the plant (that is, cost or value) as a factor while providing the suggestions. In this regard, most of the actions proposed by the said traditional solutions may lead to maintenance decisions that can unintentionally impair plant profitability resulting in incurring of heavy costs. So, this makes asset management solely a cost center for the plant and making it unable to contribute meaningfully to global level (that is, plant-wide) profitability. Thirdly, though the suggestions facilitate the assets to operate at their best performance, energy savings and maintenance costs achieved are on lower side when compared to say, cost incurred to the plant to take corrective actions in order to make the assets operate at their best performance. With this, overall profitability of the plant is heavily impacted making asset management costly affair rather than being an integral part of a larger profit center for the plant. In view of the above challenges, usage of the said traditional asset management solutions become questionable in the plant and there exists a need to develop those solutions that incur reasonable profitable costs along with efficient management of the assets in the plant at the same time.

Thus, to address the above challenges, various examples of systems and methods described herein employ various techniques based on artificial intelligence (AI) and/or machine learning (ML) to transform traditional approach of asset management from being a localized activity and a cost center into a global activity and an integral part of a larger profit center for the plant. That is, various embodiments of systems and methods described herein introduces a paradigm shift to revolutionize asset management in the plant from a reactive or localized approach to a proactive and profit-seeking approach. For this, the system described herein initially determines impact value data for an intermediate physical stream of a plurality of physical streams of the plant. It is to be noted that the plant often includes several physical streams to perform various functions during operation of the plant. In this regard, the plurality of physical streams often serves as paths between different assets in the plant for handling input ingredient(s), intermediate product(s), and/or final product(s) (for e.g., hydrocarbons, gases, etc.) during operations such as transforming, storing, releasing, transporting, and/or the like in the plant. For instance, some examples of the physical streams may be, but not limited to liquefied petroleum gas physical streams, straight-run gasoline physical streams, naphtha physical streams, and/or the like. It is to be appreciated that details of plurality of physical streams and plurality of assets may be obtained from a flow sheet model representative of a layout of the plurality of assets (alternatively, referred to as physical units) and/or the plurality of physical streams of the plant. So, the intermediate physical stream may correspond to one of the said physical streams.

Further, the impact value data described herein is associated with profitability of the plant. More particularly, the system described herein determines the impact value data for each of the plurality of physical streams using the flow sheet model. For instance, the system determines the impact value data for the said intermediate physical stream considering details associated with the intermediate physical stream in the flow sheet model. It is to be noted that the impact value data comprises input impact value data and output impact value data for corresponding physical stream. For instance, the impact value data for the intermediate physical stream comprises input impact value data and output impact value data associated with the intermediate physical stream. The input impact value data represents a value associated with one or more intermediate products received into the intermediate physical stream from at least one upstream pathway while the output impact value data represents a value associated with one or more intermediate products outputted from the intermediate physical stream to at least one downstream pathway. In this regard, the input impact value data is computed using an amount that a particular upstream pathway contributes to overall mass and/or volume of respective intermediate products associated with the intermediate physical stream, cost or amount associated with one or more input ingredients associated with at least one upstream pathway, and processing amount or processing cost incurred for respective intermediate products in the intermediate physical stream. Whereas the output impact value data is computed using an amount of the overall mass and/or volume of respective intermediate products associated with the intermediate physical stream that becomes a particular final product through a particular downstream pathway, cost or amount associated with one or more final products (e.g., final products associated with a downstream pathway associated with the intermediate physical stream), and processing amount or processing cost incurred for further processing of respective intermediate products in subsequent downstream pathway to the intermediate physical stream.

Upon determination of the impact value data for the said intermediate physical stream, the system provides a plurality of predictions for one or more assets from the plurality of assets in the plant. It is to be noted that the one or more assets may be associated with the intermediate physical stream. The plurality of predictions may be provided using one or more predefined rules and/or one or more algorithms based on artificial intelligence (AI) and/or machine learning (ML) models. Also, the plurality of predictions may be provided based on real time data and/or historical data associated with the one or more assets. In this regard, at least one prediction of the plurality of predictions is related to an anomaly of an asset of the one or more assets. For example, the system may provide a prediction that a motor is likely to fail due to instrument malfunction. Additionally, the system described herein may identify one or more faults in the one or more assets as well in view of providing the one or more predictions. In this regard, the system may identify the one or more faults using the one or more predefined rules and/or the one or more algorithms based on artificial intelligence (AI) and/or machine learning (ML) models. Also, the one or more faults may be provided based on real time data and/or historical data associated with the one or more assets. For example, the system may identify that a compressor is not operating at its rated performance. In another example, the system may identify that speed of a drive motor is constrained. Yet in another example, the system may identify that heat rejection of a condenser is insufficient.

Then, the system described herein assesses impact of each of the plurality of predictions on the profitability of the plant based at least on the impact value data. That is, the system considers the input impact value data and the output impact value data determined for the intermediate physical stream to assess impact of each of the plurality of predictions on the profitability of the plant. Additionally, the system also assesses effects of each of the plurality of predictions on overall operation of the plant as well. In this regard, the system identifies if at least one asset along the intermediate physical stream creates bottlenecks that is, which impedes the profitability of the plant along with negative effects on normal operation of the plant. The system considers fault(s) associated with the at least one asset to identify if the at least one asset impedes the profitability of the plant along with normal operations of the plant. Then, the system determines one or more constraints of the at least one asset which impede the profitability of the plant along with normal operations of the plant as a part of the assessment of impact of each of the plurality of predictions.

Further, the system prioritizes one or more predictions from the plurality of predictions based on the impact assessed for each of the plurality of predictions. That is, those predictions which have highest negative effects on the profitability of the plant as well as on normal operations of the plant are ranked so that personnel such as operators can take necessary steps/actions in the plant. For each of the one or more prioritized predictions, the system then generates one or more recommendations. The one or more recommendations often comprise details of corrective action(s) which can be undertaken by operators in the plant. Also, it is to be noted that the one or more recommendations are generated based on the impact value data. That is, the system considers effects on the profitability of the plant as well as on normal operations of the plant in view of generating the one or more recommendations. The one or more recommendations generated for each of the one or more prioritized predictions are rendered via a user interface. The one or more recommendations may be presented as a heat map on the user interface. Additionally, the system described herein allows the user to provide one or more prompts via the user interface that allows the user to understand various effects of performing the corrective action(s) on the profitability of the plant as well as on normal operations of the plant. Accordingly, the system described herein transforms traditional approach of asset management to a global activity and an integral part of a larger profit center for the plant so that asset management no longer serves as a necessary cost center to the plant. Also, this facilitates efficient management of the assets at amicable costs in the plant thereby achieving optimization of asset management in the plant.

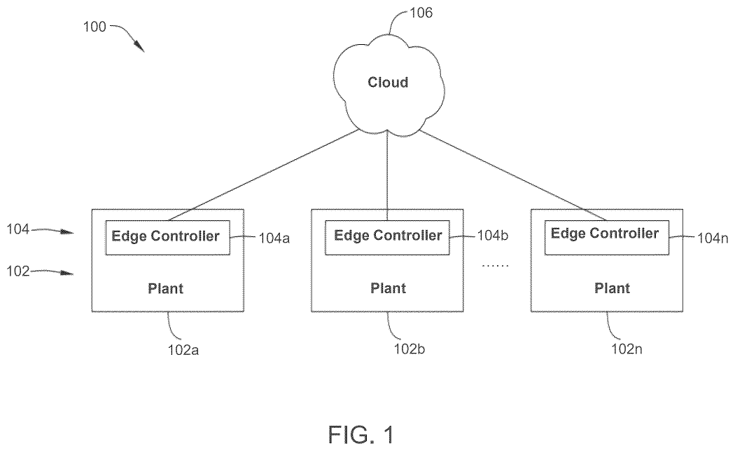

FIG. 1 illustrates a schematic diagram showing an exemplary environment comprising multiple plants, in accordance with one or more example embodiments described herein. FIG. 1 illustrates an exemplary environment 100 in which embodiments of the present disclosure may operate. Specifically, FIG. 1 illustrates one or more plants 102a, 102b, . . . 102n (collectively “plants 102”) in the exemplary environment 100. In some embodiments, for example, a plant of the plants 102 may, for example, be a processing plant that receives and processes ingredients as inputs to create a processed product, such as a hydrocarbon processing plant, a refinery, a pulp and paper plant, a chemical plant, an alumina plant, a drilling facility, a fracking field, and/or the like. The plant in some embodiments includes any number of individual assets or physical units. The physical units of the plant may perform a particular function during operation of the plant. For example, the physical units may include one or more well physical units, fracking physical units, crude processing physical units (e.g., crude processing physical units having a vacuum section), hydrotreating physical units, isomerization physical units, reforming physical units, vapor recovery physical units, fluid catalytic cracking physical units, batch blending physical units, rundown blending physical units, hydrocracking physical units, alkylation physical units, dewaxing physical units, de-asphalter physical units (e.g., propane de-asphalter physical units), aromatics reduction physical units, delayed cooker physical units, visbreaker physical units, digester physical units, thermomechanical grinding physical units, bleaching physical units, storage tank physical units, blender physical units, pump physical units, flash venting physical units, compressor physical units, cooler physical units (e.g., air cooler physical units), sensor physical units, storage physical units, flare physical units, heating, ventilation, and air (HVAC) physical units, lighting physical units, and/or the like that perform a particular operation for transforming, separating, reacting, reforming, digesting, bleaching, storing, releasing, and/or otherwise handling one or more input ingredient(s), intermediate product(s), and/or final product(s) (e.g., hydrocarbons, gases, etc.). In this regard, for example, the individual physical units of the plant may include physical units associated with a particular process performed by the plant.

The plant in some embodiments includes any number of individual physical streams. The physical streams of the plant may perform a particular function during operation of the plant. For example, the physical streams may include one or more liquefied petroleum gas physical streams, straight-run gasoline physical streams, naphtha physical streams, middle distillates physical streams, crude physical streams, heavy atmospheric gasoil physical streams, vacuum gasoil physical streams, lube base stocks physical streams, fuel gas physical streams, light gasoil physical streams, gasoline physical streams, fractionator bottoms physical streams, fuel oil physical streams, asphalt physical streams, refinery fuel physical streams, regular gasoline physical streams, solvents physical streams, aviation fuel physical streams, diesel physical streams, heating oil physical streams, lube oil physical streams, grease physical streams, industrial fuel physical streams, wood chip physical streams, brown stock physical streams, white liquor physical streams, bleached pulp physical streams, and/or the like that perform a particular operation for transforming, storing, releasing, transporting, and/or otherwise handling one or more input ingredient(s), intermediate product(s), and/or final product(s) (e.g., hydrocarbons, gases, etc.). In this regard, for example, the individual physical streams of the plant may include physical streams associated with a particular process performed by the plant.

In some embodiments, each asset and/or each individual physical stream of the plant is associated with a determinable location. The determinable location of a particular asset and/or physical stream in some embodiments represents an absolute position (e.g., GPS coordinates, latitude, and longitude locations, and/or the like) or a relative position (e.g., a point representation of the location of an asset and/or physical stream from a local origin point corresponding to the plant). In some embodiments, an asset and/or physical stream includes or otherwise is associated with a location sensor and/or software-driven location services that provide the location data representing the location corresponding to that asset and/or physical stream. In other embodiments the location of asset and/or physical stream is stored and/or otherwise predetermined within a software environment, provided by a user and/or otherwise determinable to one or more systems.

Additionally or alternatively, in some embodiments, the plant itself is associated with a determinable location. The determinable location of the plant in some embodiments represents an absolute position (e.g., GPS coordinates, latitude and longitude locations, an address, and/or the like) or a relative position of the plant (e.g., an identifier representing the location of the plant as compared to one or more other plants, one or more other buildings, an enterprise headquarters, or general description in the world for example based at least in part on continent, state, or other definable region). In some embodiments, the plant includes or otherwise is associated with a location sensor and/or software-driven location services that provide the location data corresponding to the plant. In other embodiments, the location of the plant is stored and/or otherwise determinable to one or more systems.

In some example embodiments, a cloud 106 is operably coupled with one or more plants 102a, 102b, . . . 102n, meaning that communication between the cloud 106 and one or more plants 102a, 102b, . . . 102n is enabled. The cloud 106 may represent distributed computing resources, software, platform or infrastructure services which can enable data handling, data processing, data management, and/or analytical operations on the data exchanged & transacted in the plants 102. In some example embodiments described herein, the cloud 106 represents a platform that comprises one or more services to facilitate asset management and/or overall management of the plant as well. Per this aspect, the one or more services of the cloud 106 appropriately handle, process, and/or manage the data at the cloud 106. In some example embodiments, the cloud 106 includes one or more servers that may be programmed to communicate with the one or more plants 102a, 102b, . . . 102n and to exchange data as appropriate. The cloud 106 may be a single computer server or may include a plurality of computer servers. In some example embodiments, the cloud 106 may represent a hierarchal arrangement of two or more computer servers, where perhaps a lower-level computer server (or servers) processes the data, for example, while a higher-level computer server oversees operation of the lower-level computer server or servers.

Also, in some example embodiments, each of the one or more plants 102a, 102b, . . . 102n includes a respective edge controller (alternatively, edge gateway) 104a, 104b, . . . 104n (collectively “edge controllers 104” or “edge gateways 104”). In some example embodiments, each of one or more edge controllers 104a, 104b, . . . 104n is configured to receive the data from the respective plants 102. In this regard, in some example embodiments, various assets and/or physical streams may provide the necessary data to a respective edge controller in the respective plant. In some examples, the one or more edge controllers 104a, 104b, . . . 104n may operate as intermediary node to transact appropriate data between the plants 102 and/or the cloud 106. Additionally, the data also includes metadata and/or other relevant data associated with the assets and/or physical streams in the plants 102. In some examples, each of the one or more edge controllers 104a, 104b, . . . 104n is capable of receiving the data from disparate data sources e.g., but not limited to, in different data formats and/or using various data communication protocols, from the plants 102. In this regard, each of the one or more edge controllers 104a, 104b, . . . 104n can receive & filter the data and translate the data into a common language and/or format (e.g. normalized data) for subsequent communication to the cloud 106. The common language and/or format may be compatible with and expected by the cloud 106.

In some embodiments, the environment 100 may include exemplary asset management system described herein that is configured to optimize asset management in the one or more plants 102. The asset management system may be electronically and/or communicatively coupled to the plant, individual physical units of the plant, one or more databases, and/or one or more devices associated with personnel in the plant. The asset management system may be located remotely, in proximity of, and/or within the plant. In some embodiments, the asset management system is configured via hardware, software, firmware, and/or a combination thereof, to perform data intake of one or more types of data associated with one or more of the plants 102. Additionally or alternatively, in some embodiments, the asset management system is configured via hardware, software, firmware, and/or a combination thereof, to generate and/or transmit command(s) that control, adjust, or otherwise impact operations of one or more of the plants 102 or specific asset(s)/physical unit(s) thereof, for example for controlling one or more operations of the plant. Additionally or alternatively still, in some embodiments, the asset management system is configured via hardware, software, firmware, and/or a combination thereof, to perform data reporting and/or other data output process(es) associated with monitoring or otherwise analyzing operations of one or more of the plants 102 or specific physical unit(s) thereof, for example for generating and/or outputting report(s) corresponding to the operations performed via the plant. For example, in various embodiments, the asset management system may be configured to execute and/or perform one or more operations and/or functions described herein.

The one or more databases may be configured to receive, store, and/or transmit data. In some embodiments, the one or more databases may be associated with data associated with the plant. In some embodiments, the data may be received from the plant. In this regard, for example, the plant may have one or more sensors that capture data and/or one or more datastores that store data. In some embodiments, the data may be received from the asset management system. In this regard, for example, the asset management system may be configured to identify data associated with the plant. In some embodiments, the one or more databases may be associated with data received from the plant and/or the asset management system in real-time. Additionally or alternatively, the one or more databases may be associated with data received from the plant and/or the asset management system on a periodic basis (e.g., the data may be received from the plant and/or the asset management system once per day). Additionally or alternatively, the one or more databases may be associated with historical physical representation received from the plant and/or the asset management system (e.g., physical representation previously received from the plant and/or the asset management system). Additionally or alternatively, the one or more databases may be associated with data received from the plant and/or the asset management system in response to a request for the data. Additionally or alternatively, the one or more databases may be associated with data inputted (e.g., by a user) into the asset management system and/or the one or more devices. The one or more devices may be associated with users of the asset management system. In various embodiments, the asset management system may generate and/or transmit a message, alert, or indication to a user via a device. Additionally, or alternatively, a device may be utilized by a user to remotely access the asset management system. This may be by, for example, an application operating on the device. A user may access the asset management system remotely, including one or more visualizations, reports, and/or real-time displays.

In some example embodiments, plants 102, edge controllers 104, databases, devices, and/or cloud 106 may be communicatively coupled to one another via network which may be embodied in any of a myriad of network configurations. In some embodiments, the network may be a public network (e.g., the Internet). In some embodiments, the network may be a private network (e.g., an internal localized, or closed-off network between particular devices). In some other embodiments, the network may be a hybrid network (e.g., a network enabling internal communications between particular connected devices and external communications with other devices). In various embodiments, the network may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network. Such configuration(s) include, without limitation, a wired or wireless Personal Area Network (PAN), Local Area Network (LAN), Metropolitan Area Network (MAN), Wide Area Network (WAN), and/or the like.

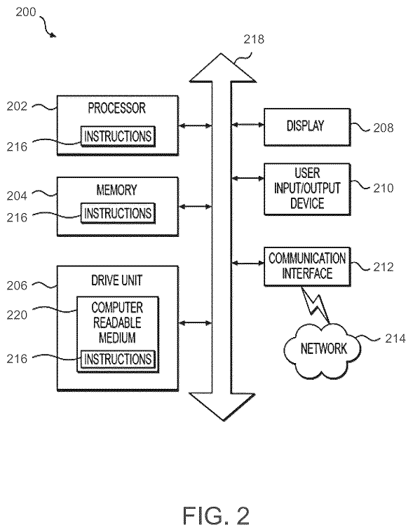

FIG. 2 illustrates a schematic diagram showing an implementation of a controller that may execute techniques in accordance with one or more example embodiments described herein. In one or more example embodiments, controller 200 described herein may include a set of instructions that can be executed to cause the controller 200 to perform any one or more of the methods or computer-based functions disclosed herein. The controller 200 may operate as a standalone device or may be connected, e.g., using a network, to other computer systems or peripheral devices.

In a networked deployment, the controller 200 may operate in the capacity of a server or as a client in a server-client user network environment, or as a peer computer system in a peer-to-peer (or distributed) network environment. The controller 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 200 can be implemented using electronic devices that provide voice, video, or data communication. Further, while the controller 200 is illustrated as a single system, the term “system” shall also be taken to include any collection of systems or sub-systems that individually or jointly execute a set, or multiple sets, of instructions to perform one or more computer functions.

As illustrated in FIG. 2, the controller 200 may include a processor 202, e.g., a central processing unit (CPU), a graphics processing unit (GPU), or both. The processor 202 may be a component in a variety of systems. For example, the processor 202 may be part of a standard computer. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The controller 200 may include a memory 204 that can communicate via a bus 218. The memory 204 may be a main memory, a static memory, or a dynamic memory. The memory 204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 204 includes a cache or random-access memory for the processor 202. In alternative implementations, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 200 may further include a display 208, such as a liquid crystal display (LCD), an organic light emitting diode (OLED), a flat panel display, a solid-state display, a cathode ray tube (CRT), a projector, a printer or other now known or later developed display device for outputting determined information. The display 208 may act as an interface for the user to see the functioning of the processor 202, or specifically as an interface with the software stored in the memory 204 or in the drive unit 206. Additionally or alternatively, the controller 200 may include an input/output device 210 configured to allow a user to interact with any of the components of controller 200. The input/output device 210 may be a number pad, a keyboard, or a cursor control device, such as a mouse, or a joystick, touch screen display, remote control, or any other device operative to interact with the controller 200. The controller 200 may also or alternatively include drive unit 206 implemented as a disk or optical drive. The drive unit 206 may include a computer-readable medium 220 in which one or more sets of instructions 216, e.g. software, can be embedded. Further, the instructions 216 may embody one or more of the methods or logic as described herein. The instructions 216 may reside completely or partially within the memory 204 and/or within the processor 202 during execution by the controller 200. The memory 204 and the processor 202 also may include computer-readable media as discussed above.

In some systems, a computer-readable medium 220 includes instructions 216 or receives and executes instructions 216 responsive to a propagated signal so that a device connected to a network 214 can communicate voice, video, audio, images, or any other data over the network 214. Further, the instructions 216 may be transmitted or received over the network 214 via a communication port or interface 212, and/or using a bus 218. The communication port or interface 212 may be a part of the processor 202 or may be a separate component. The communication port or interface 212 may be created in software or may be a physical connection in hardware. The communication port or interface 212 may be configured to connect with a network 214, external media, the display 208, or any other components in controller 200, or combinations thereof. The connection with the network 214 may be a physical connection, such as a wired Ethernet connection or may be established wirelessly as discussed below. Likewise, the additional connections with other components of the controller 200 may be physical connections or may be established wirelessly. The network 214 may alternatively be directly connected to a bus 218.

While the computer-readable medium 220 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 220 may be non-transitory, and may be tangible. The computer-readable medium 220 can include a solid-state memory such as a memory card or other package that houses one or more non-volatile read-only memories. The computer-readable medium 220 can be a random-access memory or other volatile re-writable memory. Additionally or alternatively, the computer-readable medium 220 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 200 may be connected to a network 214. The network 214 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 214 may include wide area networks (WAN), such as the Internet, local area networks (LAN), campus area networks, metropolitan area networks, a direct connection such as through a Universal Serial Bus (USB) port, or any other networks that may allow for data communication. The network 214 may be configured to couple one computing device to another computing device to enable communication of data between the devices. The network 214 may generally be enabled to employ any form of machine-readable media for communicating information from one device to another. The network 214 may include communication methods by which information may travel between computing devices. The network 214 may be divided into sub-networks. The sub-networks may allow access to all of the other components connected thereto or the sub-networks may restrict access between the components. The network 214 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

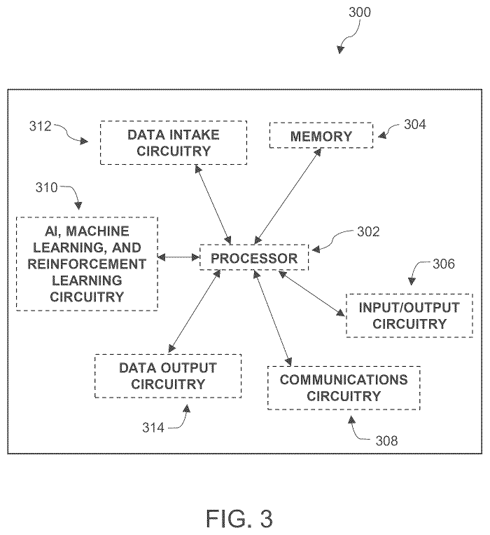

FIG. 3 illustrates a schematic diagram showing an implementation of an exemplary asset management system, in accordance with one or more example embodiments described herein. Specifically, FIG. 3 depicts an example asset management system 300 (alternatively, referred to as system 300) specially configured in accordance with at least some example embodiments of the present disclosure. For example, the asset management system 300 may be embodied as one or more of a specifically configured personal computing apparatus, a specifically configured cloud-based computing apparatus, a specifically configured embedded computing device (e.g., configured for edge computing, and/or the like). The asset management system 300 includes processor 302, memory 304, input/output circuitry 306, communications circuitry 308, and/or optional artificial intelligence (“AI”) and machine learning circuitry 310. In some embodiments, the system 300 is configured to execute and perform the operations described herein. Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, the asset management system 300 may refer to, or comprise, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the asset management system 300 embodies a particular, specially configured computing entity transformed to enable the specific operations described herein and provide the specific advantages associated therewith, as described herein.

Processor 302 or processor circuitry 302 may be embodied in a number of different ways. In various embodiments, the use of the terms “processor” should be understood to include a single core processor, a multi-core processor, multiple processors internal to the asset management system 300, and/or one or more remote or “cloud” processor(s) external to the asset management system 300. In some example embodiments, processor 302 may include one or more processing devices configured to perform independently. Alternatively, or additionally, processor 302 may include one or more processor(s) configured in tandem via a bus to enable independent execution of operations, instructions, pipelining, and/or multithreading.

In an example embodiment, the processor 302 may be configured to execute instructions stored in the memory 304 or otherwise accessible to the processor. Alternatively, or additionally, the processor 302 may be configured to execute hard-coded functionality. As such, whether configured by hardware or software methods, or by a combination thereof, processor 302 may represent an entity (e.g., physically embodied in circuitry) capable of performing operations according to embodiments of the present disclosure while configured accordingly. Alternatively, or additionally, processor 302 may be embodied as an executor of software instructions, and the instructions may specifically configure the processor 302 to perform the various algorithms embodied in one or more operations described herein when such instructions are executed. In some embodiments, the processor 302 includes hardware, software, firmware, and/or a combination thereof that performs one or more operations described herein. In some embodiments, the processor 302 (and/or co-processor or any other processing circuitry assisting or otherwise associated with the processor) is/are in communication with the memory 304 via a bus for passing information among components of the system 300.

Memory 304 or memory circuitry 304 may be non-transitory and may include, for example, one or more volatile and/or non-volatile memories. In some embodiments, the memory 304 includes or embodies an electronic storage device (e.g., a computer readable storage medium). In some embodiments, the memory 304 is configured to store information, data, content, applications, instructions, or the like, for enabling the system 300 to carry out various operations and/or functions in accordance with example embodiments of the present disclosure.

Input/output circuitry 306 may be included in the system 300. In some embodiments, input/output circuitry 306 may provide output to the user and/or receive input from a user. The input/output circuitry 306 may be in communication with the processor 302 to provide such functionality. The input/output circuitry 306 may comprise one or more user interface(s). In some embodiments, a user interface may include a display that comprises the interface(s) rendered as a web user interface, an application user interface, a user device, a backend system, or the like. In some embodiments, the input/output circuitry 306 also includes a keyboard, a mouse, a joystick, a touch screen, touch areas, soft keys a microphone, a speaker, or other input/output mechanisms. The processor 302 and/or input/output circuitry 306 comprising the processor may be configured to control one or more operations and/or functions of one or more user interface elements through computer program instructions (e.g., software and/or firmware) stored on a memory accessible to the processor (e.g., memory 304, and/or the like). In some embodiments, the input/output circuitry 306 includes or utilizes a user-facing application to provide input/output functionality to a computing device and/or other display associated with a user.

Communications circuitry 308 may be included in the system 300. The communications circuitry 308 may include any means such as a device or circuitry embodied in either hardware or a combination of hardware and software that is configured to receive and/or transmit data from/to a network and/or any other device, circuitry, or module in communication with the system 300. In some embodiments the communications circuitry 308 includes, for example, a network interface for enabling communications with a wired or wireless communications network. Additionally or alternatively, the communications circuitry 308 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 308 may include circuitry for interacting with an antenna(s) and/or other hardware or software to cause transmission of signals via the antenna(s) and/or to handle receipt of signals received via the antenna(s). In some embodiments, the communications circuitry 308 enables transmission to and/or receipt of data from a user device, one or more sensors, and/or other external computing device(s) in communication with the system 300.

Data intake circuitry 312 may be included in the system 300. The data intake circuitry 312 may include hardware, software, firmware, and/or a combination thereof, designed and/or configured to capture, receive, request, and/or otherwise gather data associated with operations of the plant. In some embodiments, the data intake circuitry 312 includes hardware, software, firmware, and/or a combination thereof, that communicates with one or more sensor(s) unit(s), and/or the like within the plant to receive particular data associated with such operations of the plant. Additionally or alternatively, in some embodiments, the data intake circuitry 312 includes hardware, software, firmware, and/or a combination thereof, that retrieves particular data associated with the plant from one or more data repository/repositories accessible to the system 300.

AI and machine learning circuitry 310 may be included in the system 300. The AI and machine learning circuitry 310 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 310 includes hardware, software, firmware, and/or a combination thereof, that identifies training data and/or utilizes such training data for training a particular machine learning model, AI, and/or other model to generate particular output data based at least in part on learnings from the training data. Additionally or alternatively, in some embodiments, the AI and machine learning circuitry 310 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 310 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 314 may be included in the system 300. The data output circuitry 314 may include hardware, software, firmware, and/or a combination thereof, that configures and/or generates an output based at least in part on data processed by the system 300. In some embodiments, the data output circuitry 314 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 314 includes hardware, software, firmware, and/or a combination thereof, that configures a particular output data object, output data file, and/or user interface for storing, transmitting, and/or displaying. For example, in some embodiments, the data output circuitry 314 generates and/or specially configures a particular data output for transmission to another system or sub-system for further processing. Additionally or alternatively, in some embodiments, the data output circuitry 314 includes hardware, software, firmware, and/or a combination thereof, that causes rendering of a specially configured user interface based at least in part on data received by and/or processing by the system 300.

In some embodiments, two or more of the sets of circuitries 302-314 are combinable. Alternatively, or additionally, one or more of the sets of circuitry 302-314 perform some or all of the operations and/or functionality described herein as being associated with another circuitry. In some embodiments, two or more of the sets of circuitry 302-314 are combined into a single module embodied in hardware, software, firmware, and/or a combination thereof. For example, in some embodiments, one or more of the sets of circuitry, for example the AI and machine learning circuitry 310, may be combined with the processor 302, such that the processor 302 performs one or more of the operations described herein with respect to the AI and machine learning circuitry 310.

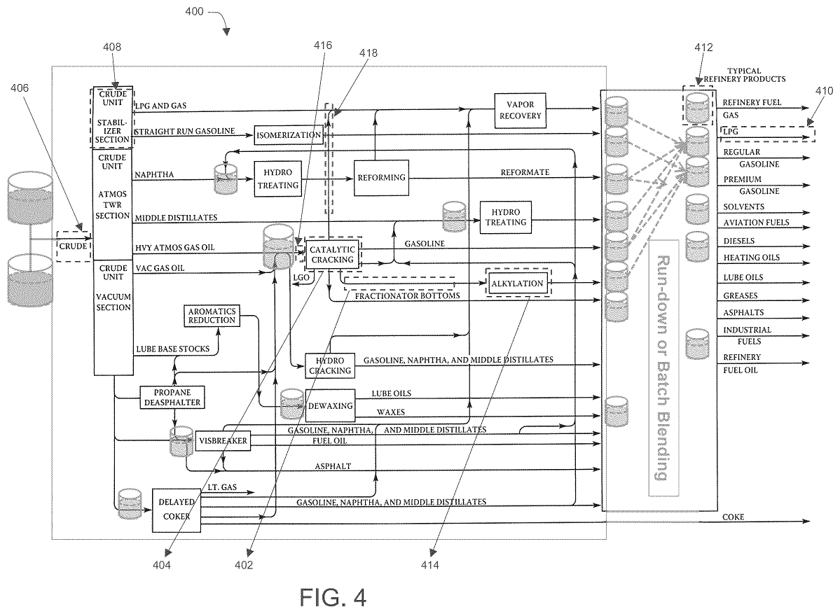

In one or more example embodiments, the system 300 described herein determines impact value data for an intermediate physical stream of a plurality of physical streams of the plant. The impact value data described herein is associated with profitability of the plant. As described in FIG. 1 of the current disclosure, the plant often includes several physical streams to perform various functions during operation of the plant. In this regard, the plurality of physical streams often serves as paths between different assets (alternatively, referred to as physical units) in the plant for handling input ingredient(s), intermediate product(s), and/or final product(s) (for e.g., hydrocarbons, gases, etc.) during operations such as transforming, storing, releasing, transporting, and/or the like. For instance, some examples of the physical streams may be, but not limited to liquefied petroleum gas physical streams, straight-run gasoline physical streams, naphtha physical streams, and/or the like. The said intermediate physical stream may correspond to one of the said physical streams. It is to be appreciated that details of plurality of physical streams and plurality of assets may be obtained from a flow sheet model representative of a layout of the plurality of assets (alternatively, referred to as physical units) and/or the plurality of physical streams of the plant which is illustrated in accordance with FIG. 4 of the current disclosure. The exemplary flow sheet model 400 illustrated in FIG. 4 may be generated by the system 300. Additionally or alternatively, the flow sheet model 400 may be received by the system 300 say, from the plant (for instance, the plant may be configured to generate the flow sheet model 400). In some embodiments, for example, the flow sheet model 400 may be generated based at least in part on physical representation data associated with the plant.

Although depicted in FIG. 4 as the flow sheet model 400 having certain physical units (e.g., a hydrotreating physical unit) and/or physical streams (e.g., a waxes physical stream), it would be understood by one skilled in the field to which this disclosure pertains that the flow sheet model 400 may include other physical units and/or physical streams not depicted in FIG. 4. Similarly, although depicted in FIG. 4 as the flow sheet model 400 having certain physical units (e.g., a hydrotreating physical unit) and/or physical streams (e.g., a waxes physical stream), it would be understood by one skilled in the field to which this disclosure pertains that the flow sheet model 400 may not include at least some of physical units and/or physical streams depicted in FIG. 4.

In some embodiments, the plurality of physical streams may include one or more input physical streams. In this regard, an input physical stream may be configured to receive one or more input ingredients into the plant. For example, as illustrated in the flow sheet model 400, the plurality of physical streams may include an input physical stream 406 (e.g., a crude physical stream). In some embodiments, the plurality of physical streams may include one or more output physical streams. In this regard, an output physical stream may be configured to output one or more final products from the plant. For example, as illustrated in the flow sheet model 400, the plurality of physical streams may include an output physical stream 410 (e.g., a liquefied petroleum physical stream). In some embodiments, the plurality of physical streams may include one or more intermediate physical streams. In this regard, an intermediate physical stream may be configured to transport one or more intermediate products through the plant. For example, as illustrated in the flow sheet model 400, the plurality of physical streams may include an intermediate physical stream 402.

In some embodiments, the plurality of physical units may include one or more input physical units. In this regard, an input physical unit may be configured to transform one or more input ingredients into one or more intermediate products. For example, as illustrated in the flow sheet model 400, the plurality of physical units may include an input physical unit 408 (e.g., a crude physical unit). In some embodiments, the plurality of physical units may include one or more output physical units. In this regard, an output physical unit may be configured to transform one or more intermediate products into one or more final products. For example, as illustrated in the flow sheet model 400, the plurality of physical units may include an output physical unit 412. In some embodiments, the plurality of physical units may include one or more intermediate physical units. In this regard, an intermediate physical unit may be configured to transform one or more intermediate products into one or more other intermediate products. For example, as illustrated in the flow sheet model 400, the plurality of physical units may include an intermediate physical unit 404 (e.g., a catalytic cracking physical unit). In some embodiments, the system 300 may be configured to identify an intermediate physical stream from the plurality of physical streams of the plant. For example, the system 300 may be configured to identify the intermediate physical stream 402.

In some embodiments, the system 300 may be configured to determine input impact value data for the intermediate physical stream 402. In some embodiments, the input impact value data for the intermediate physical stream 402 may be data representative of a value (say, a first value) associated with one or more intermediate products received into the intermediate physical stream 402. In some embodiments, the input impact value data may be determined based at least in part on the flow sheet model 400. In this regard, for example, the system 300 may be configured to determine how many upstream pathways are associated with the intermediate physical stream 402. That is, the system 300 may be configured to determine how many upstream pathways there are from the intermediate physical stream 402 to one or more input ingredients. For example, the system 300 may be configured to determine that the intermediate physical stream 402 has at least four upstream pathways including, for example, an upstream pathway that includes at least one or more of a catalytic cracking physical unit, a heavy atmospheric gas oil physical stream, a crude physical unit to reach an input ingredient (e.g., crude). Said differently, the system 300 may be configured to determine how many upstream pathways there are from which an input ingredient and/or an intermediate product generated at least in part from the input ingredient could reach the intermediate physical stream 402.

In some embodiments, for at least one upstream pathway, the system 300 may be configured to determine input contribution data. In some embodiments, input contribution data may be data representative of an amount that a particular upstream pathway contributes to the overall mass and/or volume of the intermediate products associated with the intermediate physical stream 402. For example, if the intermediate physical stream 402 is associated with four upstream pathways, the system 300 may be configured to determine input contribution data indicating that forty percent of the overall mass and/or volume of the intermediate products associated with the intermediate physical stream 402 are associated with a first upstream pathway, thirty percent of the overall mass and/or volume of the intermediate products associated with the intermediate physical stream 402 are associated with a second upstream pathway, twenty percent of the overall mass and/or volume of the intermediate products associated with the intermediate physical stream 402 are associated with a third upstream pathway, and ten percent of the overall mass and/or volume of the intermediate products associated with the intermediate physical stream 402 are associated with a fourth upstream pathway.

In some embodiments, for at least one upstream pathway, the system 300 may be configured to determine input ingredient value data associated with the intermediate physical stream 402. In some embodiments, the input ingredient value data may be data representative of a value associated with one or more input ingredients (e.g., input ingredients associated with an upstream pathway associated with the intermediate physical stream 402). For example, the input ingredient value data may be indicative of a cost associated with the one or more input ingredients (e.g., a cost associated with crude). As another example, the input ingredient value data may be indicative of an amount associated with one or more input ingredients (e.g., an amount of crude).

In some embodiments, for at least one upstream pathway, the system 300 may be configured to determine incurred processing data. In some embodiments, the incurred processing data may be data representative of an incurred processing amount associated with the intermediate physical stream 402. In this regard, for example, before reaching the intermediate physical stream 402, an intermediate product may have undergone processing by one or more of the plurality of physical units and/or plurality of physical streams in the plant. For example, an intermediate product associated with the intermediate physical stream 402 may have undergone processing in the intermediate physical unit 404 (e.g., a catalytic cracking physical unit). In this regard, for example, the incurred processing data may indicate at least a cost associated with the processing performed by the intermediate physical unit 404.

In some embodiments, the system 300 may be configured to determine the input impact value data associated with the intermediate physical stream 402 based at least in part on the flow sheet model 400, the input contribution data, the input ingredient value data, and/or the incurred processing data. In this regard, for example, the system 300 may be configured to determine the input impact value data at least in part by using equation (1):

$$Input Impact Value Data = \frac{1}{100} {\sum }_{upstream pathway j = 1}^{m} \{ Input Contribution {Data}_{j} \times ( Input Ingredient Value {Data}_{j} + Incurred Processing {Data}_{j} ) \} , \qquad ( l )$$

where there are (m) upstream pathways associated with the intermediate physical stream 402.

In some embodiments, the system 300 may be configured to determine output impact value data for the intermediate physical stream 402. In some embodiments, the output impact value data for the intermediate physical stream 402 may be data representative of a value (say, a second value) associated with one or more intermediate products outputted from the intermediate physical stream 402. In some embodiments, the output impact value data may be determined based at least in part on the flow sheet model 400. In this regard, for example, the system 300 may be configured to determine how many downstream pathways are associated with the intermediate physical stream 402. That is, the system 300 may be configured to determine how many downstream pathways there are from the intermediate physical stream 402 to one or more final products. For example, the system 300 may be configured to determine that the intermediate physical stream 402 has at least one downstream pathway, including a downstream pathway that includes at least one or more of an alkylation physical unit, a post alkylation physical stream, and/or a batch blending physical unit to reach a final product (e.g., gasoline). Said differently, the system 300 may be configured to determine how many downstream pathways there are through which an intermediate product may transit through to become a final product.

In some embodiments, for at least one downstream pathway, the system 300 may be configured to determine output contribution data. In some embodiments, output contribution data may be data representative of an amount of the overall mass and/or volume of the intermediate products associated with the intermediate physical stream 402 that becomes a particular final product through a particular downstream pathway. For example, if the intermediate physical stream 402 is associated with at least two downstream pathways, the system 300 may be configured to determine output contribution data indicating that forty percent of the overall mass and/or volume of the intermediate products associated with the intermediate physical stream 402 are associated with a first downstream pathway and sixty of the overall mass and/or volume of the intermediate products associated with the intermediate physical stream 402 are associated with a second downstream pathway.

In some embodiments, for at least one downstream pathway, the system 140 may be configured to determine final product value data associated with the intermediate physical stream 402. In some embodiments, the final product value data may be data representative of a value associated with one or more final products (e.g., final products associated with a downstream pathway associated with the intermediate physical stream 402). For example, the final product value data may be indicative of a price associated with the one or more final products (e.g., a price associated with gasoline). As another example, the final product value data may be indicative of an amount associated with one or more final products (e.g., an amount of gasoline).

In some embodiments, for at least one downstream pathway, the system 300 may be configured to determine further processing data. In some embodiments, the further processing data may be data representative of a further processing amount associated with the intermediate physical stream 402. In this regard, for example, after leaving the intermediate physical stream 402, an intermediate product may undergo processing by one or more of the plurality of physical units and/or plurality of physical streams in the plant. For example, an intermediate product associated with the intermediate physical stream 402 may undergo processing in a second intermediate physical unit 414 (e.g., an alkylation physical unit). In this regard, for example, the further processing data may indicate at least a cost associated with the processing performed by the second intermediate physical unit 414.

In some embodiments, the system 300 may be configured to determine the output impact value data associated with the intermediate physical stream 402 based at least in part on the flow sheet model 400, the output contribution data, the final product value data, and/or the further processing data. In this regard, for example, the system 300 may be configured to determine the output impact value data at least in part by using equation (2):

$$Output Impact Value Data = \frac{1}{100} {\sum }_{downstream pathway i = 1}^{n} \{ Output Contribution {Data}_{i} \times ( Final Product Value {Data}_{i} + Further Processing {Data}_{i} ) \} , \qquad ( 2 )$$

where there are (n) downstream pathways associated with the intermediate physical stream 402.

In some embodiments, the system 300 may be configured to determine differential impact value data associated with the intermediate physical stream 402. In some embodiments, the differential impact value data associated with the intermediate physical stream 402 may be determined based at least in part on the input impact value data and/or the output impact value data. In some embodiments, the differential impact value data may be data representative of a difference between the input impact value data and the output impact value data. Also, it is to be noted that the differential impact value data may indicate if an intermediate physical stream under consideration is of greater importance or lesser importance to the profitability of the plant when compared to other physical streams of the plurality of physical streams in the plant. In this regard, for example, the system 300 may be configured to determine the differential impact value data at least in part by using equation (3):

$$Differential Impact Value Data = Output Impact Value Data - Input Impact Value Data , \qquad ( 3 )$$

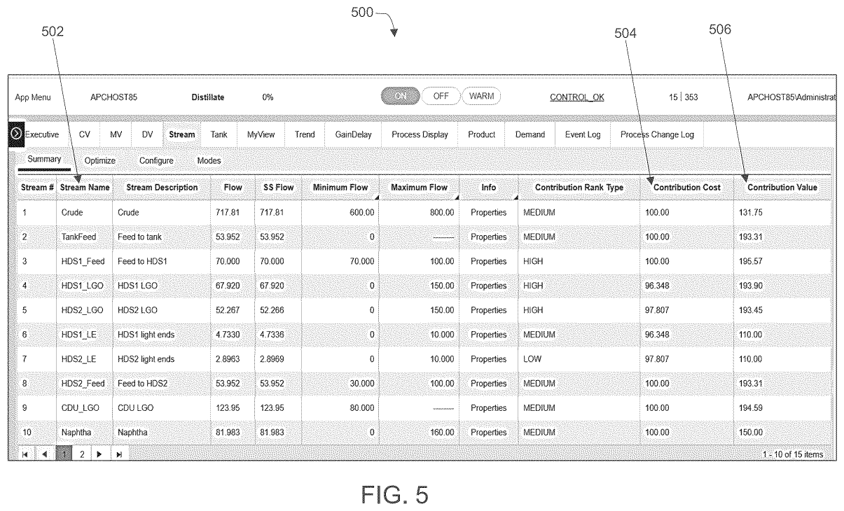

Additionally, in some embodiments, the system 300 may be configured to display the input impact value data, the output impact value data, and/or the differential impact value data associated with the intermediate physical stream 402. An exemplary user interface displaying impact value data based on the input impact value data, the output impact value data, and/or the differential impact value data is also described in accordance with FIG. 5 of the current disclosure. In some embodiments, the input impact value data, the output impact value data, and/or the differential impact value data associated with the intermediate physical stream 402 may constitute the impact value data.

Further, in one or more example embodiments, the system 300 described herein may be configured to identify an intermediate physical unit from the plurality of physical units of the plant. For example, the system 300 may be configured to identify the intermediate physical unit 404. In some embodiments the intermediate physical unit 404 may be associated with unit processing data. In some embodiments, the unit processing data may be data representative of a processing amount associated with the intermediate physical unit 404. In this regard, for example, the intermediate physical unit 404 may be configured to perform processing on an intermediate product associated with the intermediate physical unit 404. In some embodiments, the system 300 may be configured to identify one or more input intermediate physical streams associated with the intermediate physical unit 404. For example, the system 300 may be configured to identify an input intermediate physical stream 416 as one of the one or more intermediate physical streams. In some embodiments, at least one of the one or more input intermediate physical streams (e.g., input intermediate physical stream 416) may be configured to provide a first intermediate product to the intermediate physical unit 404.

In some embodiments, the one or more input intermediate physical streams may be associated with unit input contribution data. In some embodiments, the unit input contribution data may be data representative of an amount that each of the one or more input intermediate physical streams contributes to the total amount of intermediate products provided to the intermediate physical unit 304. The unit input contribution data may be determined by the system 300 as a part of determining the impact value data. For example, if the system 300 identifies a first input intermediate physical stream associated with the intermediate physical unit 404 and a second input intermediate physical stream associated with the intermediate physical unit 404, the unit input contribution data may indicate that the first input intermediate physical stream contributes forty percent of the intermediate products provided to the intermediate physical unit 404 and the second input intermediate physical stream contributes sixty percent of the intermediate products provided to the intermediate physical unit 404.

In some embodiments, the system 300 may be configured to determine input impact value data for each of the one or more input intermediate physical streams associated with the intermediate physical unit 404. For example, the system 300 may be configured to determine input impact value data as described above (e.g., at least in part by using equation (1)).

In some embodiments, the system 300 may be configured to determine unit input impact value data for the intermediate physical unit 404. In some embodiments, unit input impact value data may be data representative of a value associated with the intermediate physical unit 404. In some embodiments, the system 300 may be configured to determine the unit input impact value data based at least in part on the input impact value data associated with each of the one or more input intermediate physical streams associated with the intermediate physical unit 404 and/or the unit input contribution data. In this regard, for example, the system 300 may be configured to determine the unit input impact value data at least in part by using equation (4):

$$Unit Input Impact Value Data = \frac{1}{100} {\sum }_{input intermediate physical stream j = 1}^{m} ( Unit Input Contribution {Data}_{j} \times Input Impact Value {Data}_{j} , \qquad ( 4 )$$

where there are (m) input intermediate physical streams associated with the intermediate physical unit 404.

In some embodiments, the system 300 may be configured to identify one or more output intermediate physical streams associated with the intermediate physical unit 404. For example, the system 300 may be configured to identify output intermediate physical stream 418. In some embodiments, at least one of the one or more output intermediate physical streams (e.g., output intermediate physical stream 418) may be configured to receive a second intermediate product from intermediate physical unit 404. In this regard, for example, the intermediate physical unit 404 may be configured to generate the second intermediate product based at least in part on the first intermediate product (e.g., the first intermediate product being provided to the intermediate physical unit 404 by at least one of the one or more input intermediate physical streams associated with the intermediate physical unit 404).

In some embodiments, the one or more output intermediate physical streams may be associated with unit output contribution data. In some embodiments, the unit output contribution data may be data representative of an amount that each of the one or more output intermediate physical streams associated with contributes to the total amount of intermediate products received from the intermediate physical unit 404. For example, if the system 300 identifies a first output intermediate physical stream associated with the intermediate physical unit 404 and a second output intermediate physical stream associated with the intermediate physical unit 404, the unit output contribution data may indicate that the first output intermediate physical stream contributes twenty percent of the intermediate products received from the intermediate physical unit 404 and the second output intermediate physical stream contributes eighty percent of the intermediate products received from the intermediate physical unit 404.

In some embodiments, the system 300 may be configured to determine output impact value data for each of the one or more output intermediate physical streams associated with the intermediate physical unit 404. For example, the system 300 may be configured to determine output impact value data as described above (e.g., at least in part by using equation (2)).

In some embodiments, the system 300 may be configured to determine unit output impact value data for the intermediate physical unit 404. In some embodiments, unit output impact value data may be data representative of a value associated with the intermediate physical unit 404. In some embodiments, the system 300 may be configured to determine the unit output impact value data based at least in part on the output impact value data associated with each of the one or more output intermediate physical streams associated with the intermediate physical unit 404 and/or the unit output contribution data. In this regard, for example, the system 300 may be configured to determine the unit output impact value data at least in part by using equation (5):

$$Unit Output Impact Value Data = \frac{1}{100} {\sum }_{\begin{matrix}output intermediate \\ physical stream i = 1\end{matrix}}^{n} ( Unit Output Contribution {Data}_{i} \times Output Impact Value {Data}_{i} , \qquad ( 5 )$$

where there are (n) output intermediate physical streams associated with the intermediate physical unit 404.

In some embodiments, the system 300 may be configured to determine differential unit impact value data associated with the intermediate physical unit 404. In some embodiments, the differential unit impact value data associated with the intermediate physical unit 404 may be determined based at least in part on the unit input impact value data, the unit output impact value data, and/or the unit processing data. In some embodiments, the differential unit impact value data may be data at least partially representative of a difference between the unit input impact value data and the unit output impact value data. Also, it is to be noted that the differential unit impact value data may indicate if an intermediate physical unit under consideration is of greater importance or lesser importance to the profitability of the plant when compared to other physical units of the plurality of physical units in the plant. In this regard, for example, the system 300 may be configured to determine the differential unit impact value data at least in part by using equation (6):

$$Differential Unit Impact Value Data = Unit Output Impact Value Data - Unit Input Impact Value Data - Unit Processing Data , \qquad ( 6 )$$

Additionally, in some embodiments, the system 300 may be configured to display the unit input impact value data, the unit output impact value data, and/or the differential unit impact value data associated with the intermediate physical unit 404 along with the input impact value data, the output impact value data, and/or the differential impact value data associated with the intermediate physical stream 402 as well. In this regard, the system 300 may be configured to display the unit input impact value data, the unit output impact value data, and/or the differential unit impact value data associated with the intermediate physical unit 404 in a manner as described in accordance with FIG. 5 of the current disclosure. Also, in some embodiments, the unit input impact value data, the unit output impact value data, and/or the differential unit impact value data associated with the intermediate physical unit 404 along with the input impact value data, the output impact value data, and/or the differential impact value data associated with the intermediate physical stream 402 may constitute the impact value data.

Upon determination of the impact value data for the said intermediate physical stream, in one or more example embodiments, the system 300 described herein provides a plurality of predictions for one or more assets from a plurality of assets in the plant. It is to be noted that the one or more assets may be associated with the intermediate physical stream in consideration. That is, in some embodiments, the one or more assets may be configured to process one or more products handled along the intermediate physical stream. Per this aspect, the one or more assets may be involved directly and/or indirectly with regards to processing the one or more products handled along the intermediate physical stream. Additionally, the one or more assets may be located along the intermediate physical stream. For instance, as illustrated in FIG. 4 of the current disclosure, an example intermediate physical stream 402 comprises a catalytic cracking physical unit 404 along with an alkylation physical unit 414. It is to be noted that these physical units i.e., the catalytic cracking physical unit 404 and the alkylation physical unit 414 are located along the intermediate physical stream 402. Also, the catalytic cracking physical unit 404 and the alkylation physical unit 414 facilitate processing of few intermediate products handled along the intermediate physical stream 402. Accordingly, the catalytic cracking physical unit 404 and the alkylation physical unit 414 constitute to the one or more assets associated with the intermediate physical stream 402 which is under consideration.

With regards to providing the plurality of predictions, the system 300 described herein relies on one or more predefined rules and/or one or more algorithms. Per this aspect, the one or more algorithms may be based on artificial intelligence (AI) and/or machine learning (ML) models. These models may be rigorously trained based at least on relevant data associated with the plant. Also, the plurality of predictions may be provided by the system 300 based on real time data and/or historical data associated with the one or more assets. In this regard, at least one prediction of the plurality of predictions may be related to an anomaly of an asset of the one or more assets. For instance, the system 300 may provide a prediction that a motor is likely to fail due to instrument malfunction. Additionally, it is to be noted that the system 300 also identifies one or more faults in the one or more assets in view of providing the one or more predictions. In this regard, the system 300 may identify the one or more faults using the one or more predefined rules and/or the one or more algorithms based on artificial intelligence (AI) and/or machine learning (ML) models. It is to be appreciated that the one or more faults may be identified based on real time data and/or historical data associated with the one or more assets. For instance, the system 300 may identify that a compressor is not operating at its rated performance. In another instance, the system 300 may identify that speed of a drive motor is constrained. Yet in another instance, the system 300 may identify that heat rejection of a condenser is insufficient. Based at least on such faults, the system 300 may provide the plurality of predictions for the one or more assets. The one or more predictions and/or the one or more faults may be provided by the system 300 considering one or more predefined thresholds as well. In this regard, the one or more predefined thresholds may be defined based at least on normal operating conditions and/or rated operated conditions associated with the one or more assets.

Further, it is to be noted that the system 300 may provide appropriate recommendations for corresponding assets of the one or more assets based at least on the one or more predictions and/or the one or more faults. That is, the system 300 may provide appropriate recommendations only for selective assets from the one or more assets instead of all of the one or more assets considering various factors. For example, a particular intermediate physical stream may be associated with say, 50 assets. Out of these 50 assets, there may be 10 assets which may be operating at normal operating conditions but below rated operated conditions while 5 other assets may be operating at abnormal operating conditions i.e., below normal operating conditions. In this regard, the system 300 may identify cause(s) for below rated operated conditions along with abnormal operating conditions of respective assets. Then, the system 300 may identify fault(s) in respective assets based at least on the cause(s) and may also provide appropriate prediction(s) for corresponding assets as well. Though the system 300 identifies fault(s) and/or provides prediction(s) for corresponding assets, the system 300 may selectively generate appropriate recommendations only for say, 5 assets operating at normal operating conditions along with 2 assets operating at abnormal operating conditions. So, the system 300 described herein provides such recommendations for selective assets based on various factors in view of optimizing asset management in the plant which is also further described in more details. Accordingly, the system 300 described herein facilitates selective elevation of operation of assets at normal operating conditions to rated operated conditions primarily, along with elevation of operation of few assets at abnormal operating conditions to normal operating conditions.

Then, in one or more example embodiments, the system 300 described herein assesses impact of each of the plurality of predictions on the profitability of the plant based at least on the impact value data. That is, in some embodiments, the system 300 may consider the input impact value data and/or the output impact value data determined for the intermediate physical stream in consideration to assess impact of each of the plurality of predictions on the profitability of the plant. Also, the system 300 may consider differential impact value data along with the input impact value data and/or the output impact value data to assess impact of each of the plurality of predictions on the profitability of the plant. More particularly, the system 300 described herein assesses how each of the plurality of predictions impacts the profitability of the plant considering at least the impact value data into account. That is, the system 300 assesses if each prediction of the plurality of predictions positively or negatively affects the profitability of the plant. In this regard, the system 300 may assess if addressing each prediction of the plurality of predictions positively or negatively affects: the input impact value data i.e., a value associated with one or more intermediate products received into the intermediate physical stream and/or the output impact value data i.e., a value associated with one or more intermediate products outputted from the intermediate physical stream. Also, the system 300 may assess if addressing each prediction of the plurality of predictions positively or negatively affects the differential impact value data. Additionally, the system 300 also considers the differential impact value data to assess if the intermediate physical stream in consideration is of economic importance to the profitability of the plant. In the case that addressing a prediction of the plurality of predictions has positive effects on the input impact value data, the output impact value data, and/or the differential impact value data, and that the intermediate physical stream in consideration is of economic importance to the profitability of the plant, the system 300 classifies addressing such prediction as significant to the plant's profitability. For example, an asset of the one or more assets, say a heat exchanger in an intermediate physical stream may be operating at its normal operating conditions but below its rated operating conditions. The system 300 may provide a prediction that the heat exchanger is likely to fail in a span of a week. At the same time, the system 300 may assess if failing of heat exchanger significantly impacts the input impact value data, the output impact value data, and/or the differential impact value data. In this regard, the system 300 may assess that failing of heat exchanger may lead to negative effects such as shutting down of heat exchanger along with other related assets in the same intermediate physical stream which may be processing certain intermediate products which is of greater value i.e., of higher economic importance to the plant's profitability. So, addressing this prediction may be classified by the system 300 as significant to the plant's profitability. Also, it is to be noted that the system 300 also assesses effects of each of the plurality of predictions on overall operation of the plant as well. This assessment may be based at least on the impact value data as well.

Additionally or alternatively, the system 300 described herein also assesses impact of each of the fault(s) related to the one or more predictions on the profitability of the plant based at least on the impact value data. That is, in some embodiments, the system 300 may consider the input impact value data and/or the output impact value data determined for the intermediate physical stream in consideration to assess impact of each of the fault(s) on the profitability of the plant. Also, the system 300 may consider differential impact value data along with the input impact value data and/or the output impact value data to assess impact of each of the fault(s) on the profitability of the plant. More particularly, the system 300 described herein assesses how each of the fault(s) impacts the profitability of the plant considering the impact value data into account. That is, the system 300 assesses if each of the identified fault(s) positively or negatively affects the profitability of the plant. In this regard, the system 300 may assess if addressing each of the identified fault(s) positively or negatively affects: the input impact value data i.e., a value associated with one or more intermediate products received into the intermediate physical stream and/or the output impact value data i.e., a value associated with one or more intermediate products outputted from the intermediate physical stream. Also, the system 300 may assess if addressing each of the identified fault(s) positively or negatively affects the differential impact value data. Additionally, the system 300 also considers the differential impact value data to assess if the intermediate physical stream in consideration is of economic importance to the profitability of the plant. In the case that addressing at least one fault of the fault(s) has positive effects on the input impact value data, the output impact value data, and/or the differential impact value data, and that the intermediate physical stream in consideration is of economic importance to the profitability of the plant, the system 300 classifies addressing the at least one fault as significant to the plant's profitability. For example, an asset of the one or more assets, say a heat exchanger in an intermediate physical stream may be operating at its normal operating conditions but below its rated operating conditions. The system 300 may identify that a bearing of the heat exchanger is faulty, and this is causing operation of the heat exchanger below its rated performance. At the same time, the system 300 may assess that operation of the heat exchanger below its rated performance due to this fault significantly impacts the input impact value data, the output impact value data, and/or the differential impact value data. In this regard, the system 300 may assess that under-performance of heat exchanger may lead to negative effects on processing of certain intermediate products which is of greater value i.e., of higher economic importance to the plant's profitability. So, addressing this fault may be classified by the system 300 as significant to the plant's profitability. Also, it is to be noted that the system 300 also assesses effects of each of the identified fault(s) on overall operation of the plant as well. This assessment may be based at least on the impact value data as well.

While in some embodiments, the system 300 described may also consider the unit input impact value data and/or the unit output impact value data determined for the intermediate physical unit(s) or asset(s) to assess impact of each of the plurality of predictions and/or the fault(s) on the profitability of the plant. Also, the system 300 may consider the differential unit impact value data along with the unit input impact value data and/or the unit output impact value data to assess impact of each of the plurality of predictions and/or the fault(s) on the profitability of the plant. That is, the system 300 assesses if each of the plurality of predictions and/or the fault(s) positively or negatively affects the profitability of the plant. In this regard, the system 300 may assess if addressing each of the plurality of predictions and/or the fault(s) positively or negatively affects: the unit input impact value data and/or the unit output impact value data. Also, the system 300 may assess if addressing each of the plurality of predictions and/or the fault(s) positively or negatively affects the differential unit impact value data. Additionally, the system 300 may also consider the differential unit impact value data to assess if the intermediate physical unit(s) or asset(s) in the intermediate physical stream in consideration is of economic importance to the profitability of the plant. Provided that prediction(s) and/or fault(s) are often related to the intermediate physical unit(s) or asset(s) in the intermediate physical stream in consideration, the system 300 identifies if at least one asset along the intermediate physical stream creates bottlenecks that is, which impedes the profitability of the plant along with negative effects on normal operation of the plant. In the case that some of the intermediate physical unit(s) are of economic importance i.e., which are important for improving the plant's profitability, the system 300 classifies addressing such prediction(s) and/or the fault(s) related to those intermediate physical unit(s) as significant to the plant's profitability. Also, the system 300 identifies at least one asset along the intermediate physical stream in the case that it creates bottlenecks that is, which impedes the profitability of the plant along with negative effects on normal operation of the plant. Further, the system 300 also determines one or more constraints of the at least one asset which impedes the profitability of the plant and normal operations of the plant so that appropriate action(s) may be undertaken in the plant.

Then, in one or more example embodiments, the system 300 described herein prioritizes one or more predictions from the plurality of predictions based on the impact assessed for each of the plurality of predictions. That is, those predictions which have highest negative effects on the profitability of the plant as well as on normal operations of the plant are ranked. Said alternatively, those predictions which when addressed in the plant have highest positive impact in the profitability of the plant as well as on normal operations of the plant are ranked. In this regard, the system 300 may generate a ranked list of one or more predictions from the plurality of predictions. Additionally or alternatively, the system 300 described herein prioritizes fault(s) as well based on the impact assessed for each of the fault(s). That is, those fault(s) which have highest negative effects on the profitability of the plant as well as on normal operations of the plant are ranked. Said alternatively, those fault(s) which when addressed in the plant have highest positive impact in the profitability of the plant as well as on normal operations of the plant are ranked. In this regard, the system 300 may generate a ranked list of one or more fault(s). It is to be appreciated that the system 300 prioritizes prediction(s) and/or fault(s) in a manner that the plant's profitability is of primary importance. With this, the system 300 described herein follows a dynamic approach which ensures that the prioritized prediction(s) and/or fault(s) relate to those assets which constitute to profit-limiting assets so that their operations is consistently improved. Also, this approach actively targets bottleneck assets for improvement to maximize profitability instead of addressing prediction(s) and/or fault(s) related to those assets whose contribution to the plant's profitability is less significant.

Further, in one or more example embodiments, the system 300 generates one or more recommendations for each of the one or more prioritized predictions. In this regard, the one or more recommendations generated by the system 300 often comprise details of corrective action(s) which can be undertaken by personnel such as operators in the plant. For instance, a recommendation may comprise an action to check one or more manual valves in a heat exchanger of a particular intermediate physical stream in view of a prediction provided for the heat exchanger. Also, it is to be noted that the one or more recommendations are generated based on the impact value data. In this regard, the one or more recommendations may be generated by the system 300 based at least on the input impact value data, the output impact value data, and/or the differential impact value data. Additionally, the one or more recommendations may be generated by the system 300 based at least on the unit input impact value data, the unit output impact value data, and/or the differential unit impact value data. More particularly, the system considers effects on the profitability of the plant as well as on normal operations of the plant in view of generating the one or more recommendations. Additionally or alternatively, the system 300 also generates one or more recommendations for each of the fault(s). In this regard, the one or more recommendations generated by the system 300 often comprise details of corrective action(s) which can be undertaken by personnel such as operators in the plant. For instance, a recommendation may comprise an action to maximize heat rejection capability in a condenser of a particular intermediate physical stream in view of a fault identified for the condenser. Also, it is to be noted that the one or more recommendations are generated based on the impact value data. In this regard, the one or more recommendations may be generated by the system 300 based at least on the input impact value data, the output impact value data, and/or the differential impact value data. Additionally, the one or more recommendations may be generated by the system 300 based at least on the unit input impact value data, the unit output impact value data, and/or the differential unit impact value data. More particularly, the system considers effects on the profitability of the plant as well as on normal operations of the plant in view of generating the one or more recommendations.

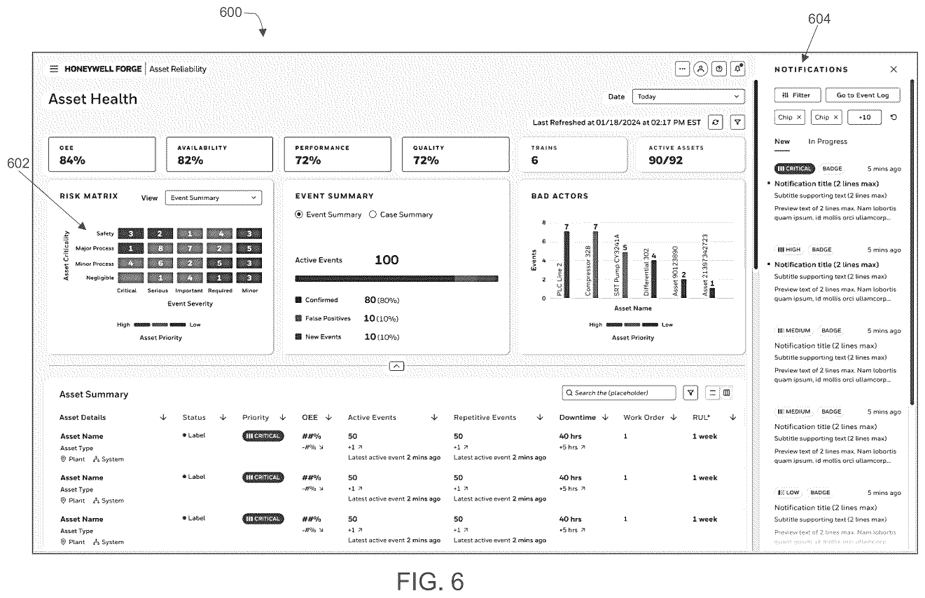

Accordingly, the system 300 described herein envisions current and future scenarios or timeframes using the prediction(s) and/or the fault(s). This allows the system 300 to identify potential future bottlenecks thereby enabling just-in-time performance improvements before asset limitations significantly impact operations and then plant profitability. This forward-looking approach provides personnel such as operators or maintenance crews associated with the plant with appropriate recommendations that is, early warnings about potential issues, helping them prepare parts and resources in advance, and/or the like thus optimizing timing and efficiency of maintenance efforts. Also, in one or more example embodiments, the system 300 also provides appropriate notifications (audio notification(s) and/or visual notification(s)) upon generating the one or more recommendations. Further, in one or more example embodiments, the system 300 also renders the one or more recommendations generated for each of the one or more prioritized predictions via a user interface. An exemplary user interface displaying recommendations is also described in accordance with FIG. 6 of the current disclosure.

Additionally or alternatively, in one or more example embodiments, the system 300 also allows a user associated with the plant to provide one or more prompts via the user interface. In this regard, the user may correspond to personnel such as an operator or maintenance crew member of the plant. Also, at least one prompt of the one or more prompts may relate to one or more operations of at least one asset and/or the profitability of the plant. The one or more prompts may be received at the system 300 via the user interface in the form of audio, text, image, and/or the like. In response to receiving the one or more prompts, the system 300 may appropriately process the one or more prompts to provide suitable responses to the one or more prompts such that the responses also relate at least to one or more operations of at least one asset and/or the profitability of the plant. The system 300 described herein may utilize the one or more algorithms to provide suitable responses to the one or more prompts. It is to be noted that the one or more algorithms may be based on artificial intelligence (AI) and/or machine learning (ML) models. These models may be rigorously trained based at least on relevant data associated with the plant. The one or more prompts described here allows the user to understand various effects of performing the corrective action(s) on the profitability of the plant as well as on normal operations of the plant. Additionally, the system 300 may generate additional recommendation(s) in view of the prompt(s) and/or the response(s) in view of optimizing asset management in the plant. Accordingly, the system 300 described herein transforms traditional approach of asset management to a global activity and an integral part of a larger profit center for the plant so that asset management no longer serves as a high-cost center to the plant. Also, this facilitates efficient management of the assets at amicable costs in the plant thereby achieving optimization of asset management in the plant.

FIG. 5 illustrates a schematic diagram showing an exemplary user interface associated with an exemplary asset management system, in accordance with one or more example embodiments described herein. The exemplary user interface 500 described herein displays the impact value data which is described in accordance with FIG. 3 of the current disclosure. In this regard, the impact value data for each of a plurality of intermediate physical streams 502 in the plant may be rendered on the user interface 500. Each of the plurality of intermediate physical streams 502 may be provided with an identifier such as “Crude”, “TankFeed”, and/or the like as illustrated in FIG. 5. The identifiers illustrated in FIG. 5 are exemplary only and is only for understanding purpose. The impact value data may be represented by contribution value 504 and contribution cost 506 in the user interface 500. That is, the system 300 may derive the contribution value 504 and the contribution cost 506 based at least on the input impact value data, the output impact value data, and/or the differential impact value data. Additionally, the system 300 may also consider the unit input impact value data, the unit output impact value data, and/or the differential unit impact value data to derive the contribution value 504 and the contribution cost 506 as well. It is to be noted that values represented under the contribution value 504 and the contribution cost 506 in FIG. 5 are exemplary only and is only for understanding purpose. Accordingly, the system 300 described facilitates users such as personnel associated with the plant to understand how impact value data is linked to each of the plurality of intermediate physical streams 502.

In some embodiments, the system 300 may be configured to update the user interface 500 in real-time. For example, the system 300 may be configured to update the user interface 500 as the system 300 determines the impact value data. Additionally or alternatively, the system 300 may be configured to update the user interface 500 on a periodic basis. For example, the system 300 may be configured to update the user interface 500 once per day. Additionally or alternatively, the system 300 may be configured to update the user interface 500 upon being triggered to update the user interface 500. It is to be appreciated that the system 300 utilizes the contribution value 504 and the contribution cost 506 to assess impact of prediction(s) and/or fault(s) on the profitability of the plant, prioritize prediction(s) and/or fault(s), and generate appropriate recommendations for prioritized prediction(s) and/or fault(s) as described in accordance with FIG. 3 of the current disclosure.

FIG. 6 illustrates a schematic diagram showing an exemplary user interface associated with an exemplary asset management system, in accordance with one or more example embodiments described herein. The exemplary user interface 600 described herein displays one or more recommendations generated by the system 300 as described in FIG. 3 of the current disclosure. In this regard, the user interface 600 may dynamically render a risk matrix 602 associated with assets in the plant along with one or more notifications 604. The risk matrix 602 may be rendered as a heat map depicting asset priority derived based at least on asset criticality and severity of events (prediction(s) and/or faults(s)) associated with respective assets. This heat map may be determined and dynamically updated based at least on the impact value data which is described in accordance with FIG. 3 of the current disclosure. Additionally, as illustrated in FIG. 6, the heat map may comprise scores for asset criticality and severity of events for each of the respective assets. It is to be noted that scores, priority, criticality, and severity of events associated with assets represented in FIG. 6 are exemplary only and is only for understanding purpose. Further, the user interface 600 may also render the notifications 604 which comprise the one or more recommendations generated by the system 300 as described in accordance with FIG. 3 of the current disclosure along with a priority of corresponding recommendation. It is to be noted that recommendations shown in the user interface 600 are exemplary only and is only for understanding purpose. In some embodiments, the system 300 may be configured to update the user interface 600 in real-time. For example, the system 300 may be configured to update the user interface 600 as the system 300 determines the impact value data. Additionally or alternatively, the system 300 may be configured to update the user interface 600 on a periodic basis. For example, the system 300 may be configured to update the user interface 600 once per day. Additionally or alternatively, the system 300 may be configured to update the user interface 600 upon being triggered to update the user interface 600.

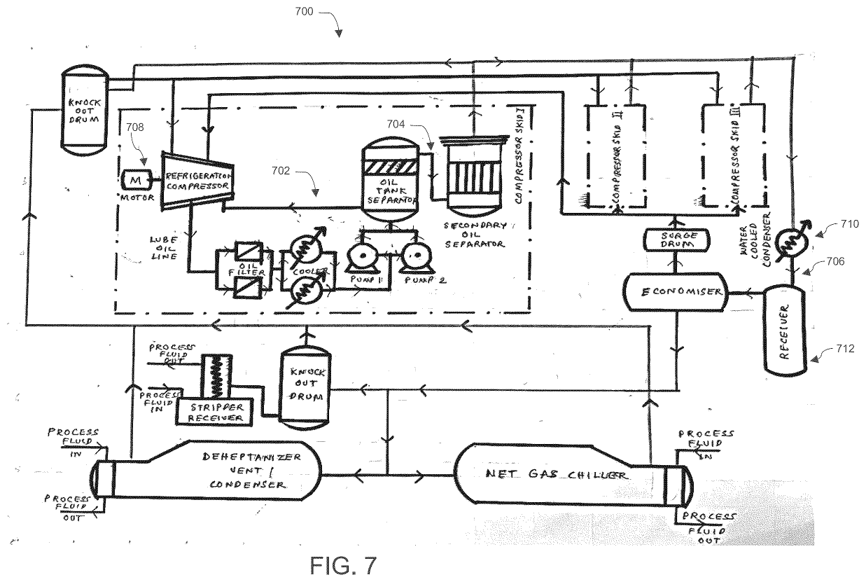

FIG. 7 illustrates a schematic diagram showing an exemplary use case associated with an exemplary asset management system, in accordance with one or more example embodiments described herein. FIG. 7 described herein illustrates for example, a process flow diagram 700 of a natural gas manufacturing unit in the plant. The diagram 700 may be derived based at least on a flow sheet model associated with the plant. The overall natural gas manufacturing unit may comprise for example, assets or physical units such as compressor units, condenser units, receiver units, chiller units, actuators, and/or the like. The overall unit may be operational thereby producing a certain quantity of natural gas in the plant. However, this quantity may be less than an expected quantity or throughput. In this regard, the system 300 described in accordance with FIG. 3 of the current disclosure may generate appropriate recommendations to increase the throughput from the unit. To generate appropriate recommendations, the system 300 may initially determine impact value data for each of the one or more intermediate physical streams (for example, indicated as 702, 704, 706 in the diagram 700) of the unit in the plant in a manner as described in accordance with FIG. 3 of the current disclosure.

Further, the system 300 described herein may provide a prediction that compressor motor 708 is likely to fail in a span of next 24 hours while the system 300 may also identify that there is a fault in condenser 710. Additionally, the system 300 may also provide another prediction that receiver 712 is likely to get corroded in a span of a week. The system 300 may provide the said predictions and/or the said fault based at least on a comparison of current operations with rated operations and/or expected operations of respective assets. Then, the system 300 may assess impact of the said predictions and/or the said fault based at least on the impact value data in a manner as described in accordance with FIG. 3 of the current disclosure. As a result, the system 300 may assess that failure of compressor motor 708 has the highest negative impact on the plant's profitability when compared to corrosion of receiver 712 and the fault observed in condenser 710. Said alternatively, as a result, the system 300 may assess that addressing the prediction corresponding to failure of the compressor motor 708 has positive effects on the plant's profitability over addressing the corrosion of receiver 712 and addressing the fault observed in condenser 710. Additionally, the system 300 may assess that the intermediate physical stream 702 along with the compressor motor 708 is of economic importance to the profitability of the plant considering at least the impact value data for intermediate physical stream 702. Also, the system 300 identifies that the compressor motor 708 is that asset which is limiting overall throughput and is serving as a bottleneck to the plant's profitability. In view of such assessment, the system 300 may prioritize addressing the prediction related to failure of the compressor motor 708 over addressing other prediction and the fault. Accordingly, the system 300 may generate a recommendation and render the same via a user interface. The recommendation may comprise an action, say for an operator in the plant to check if compressor motor amperage supplied is maximized or not. The system 300 may also provide appropriate notifications (audio notification(s) and/or visual notification(s)) to the operator upon generating the said recommendation. Accordingly, the system 300 described herein facilitates asset management to be a global activity and an integral part of a larger profit center for the plant so that asset management no longer serves as a high-cost center to the plant. Also, this results in efficient management of the assets at amicable costs in the plant thereby achieving optimization of asset management in the plant.

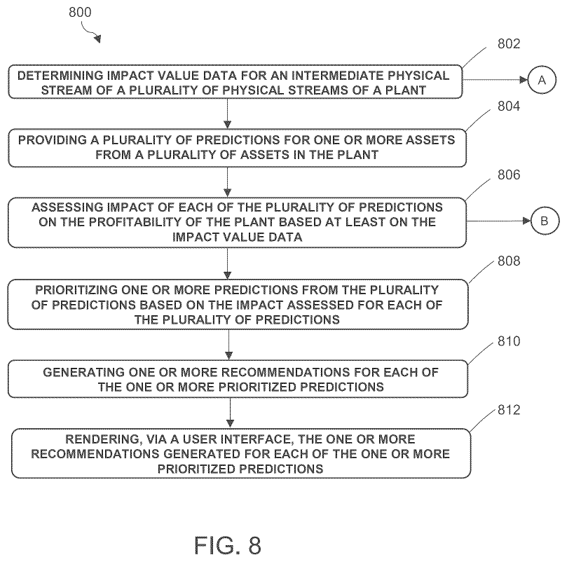

FIG. 8 illustrates a flowchart showing a method described in accordance with one or more example embodiments described herein. In this regard, FIG. 8 illustrates operations that may be performed by the system 300. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800. At step 802 of the exemplary flowchart 800, the system 300 determines impact value data for an intermediate physical stream of a plurality of physical streams of a plant. At step 804 of the exemplary flowchart 800, the system 300 provides a plurality of predictions for one or more assets from a plurality of assets in the plant. While at step 806 of the exemplary flowchart 800, the system 300 assesses impact of each of the plurality of predictions on the profitability of the plant based at least on the impact value data. At step 808 of the exemplary flowchart 800, the system 300 prioritizes one or more predictions from the plurality of predictions based on the impact assessed for each of the plurality of predictions. Further, at step 810 of the exemplary flowchart 800, the system 300 generates one or more recommendations for each of the one or more prioritized predictions. Additionally, at step 812 of the exemplary flowchart 800, the system 300 renders via a user interface, the one or more recommendations generated for each of the one or more prioritized predictions.

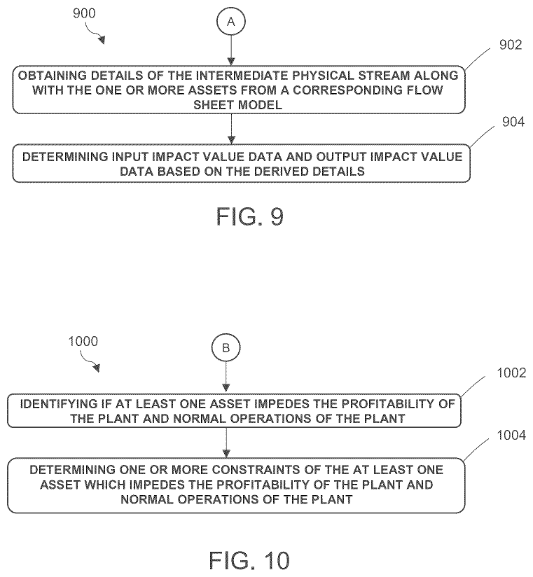

FIG. 9 illustrates a flowchart showing a method described in accordance with one or more example embodiments described herein. In this regard, FIG. 9 illustrates operations that may be performed by the system 300. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900. At step 902 of the exemplary flowchart 900, the system 300 obtains details of the intermediate physical stream along with the one or more assets from a corresponding flow sheet model. While at step 904 of the exemplary flowchart 900, the system 300 determines input impact value data and output impact value data based on the derived details.

FIG. 10 illustrates a flowchart showing a method described in accordance with one or more example embodiments described herein. In this regard, FIG. 10 illustrates operations that may be performed by the system 300. In some embodiments, the example method 1000 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1000. At step 1002 of the exemplary flowchart 1000, the system 300 identifies if at least one asset impedes the profitability of the plant and normal operations of the plant. While at step 1004 of the exemplary flowchart 1000, the system 300 determines one or more constraints of the at least one asset which impedes the profitability of the plant and normal operations of the plant.

The foregoing embodiments are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation. It is intended that the specification and examples be considered as exemplary only, with a true scope and spirit of the disclosure being indicated by the following claims.

1. A method for optimizing asset management in a plant, the method comprising:
determining impact value data for an intermediate physical stream of a plurality of physical streams of the plant, wherein the impact value data is associated with profitability of the plant;
providing a plurality of predictions for one or more assets from a plurality of assets in the plant, wherein at least one prediction is related to an anomaly of an asset of the one or more assets;
assessing impact of each of the plurality of predictions on the profitability of the plant based at least on the impact value data;
prioritizing one or more predictions from the plurality of predictions based on the impact assessed for each of the plurality of predictions;
generating one or more recommendations for each of the one or more prioritized predictions; and
rendering, via a user interface, the one or more recommendations generated for each of the one or more prioritized predictions.

2. The method of claim 1, wherein determining the impact value data comprises:
obtaining details of the intermediate physical stream along with the one or more assets from a corresponding flow sheet model; and
determining input impact value data and output impact value data based on the obtained details, wherein the input impact value data represents a first value associated with one or more first intermediate products received into the intermediate physical stream from at least one upstream pathway, and wherein the output impact value data represents a second value associated with one or more second intermediate products outputted from the intermediate physical stream to at least one downstream pathway.

3. The method of claim 1, wherein providing the plurality of predictions in the plant comprises identifying one or more faults in the one or more assets using at least one of one or more predefined rules and one or more algorithms.

4. The method of claim 1, wherein assessing the impact of each of the plurality of predictions comprises:
identifying if at least one asset impedes the profitability of the plant and normal operations of the plant; and
determining one or more constraints of the at least one asset which impedes the profitability of the plant and normal operations of the plant.

5. The method of claim 1, wherein generating the one or more recommendations comprises generating one or more corrective actions based on the impact value data.

6. The method of claim 1, wherein rendering the one or more recommendations comprises presenting the one or more recommendations via the user interface as a heat map.

7. The method of claim 1, further comprising receiving one or more prompts via the user interface from a user associated with the plant, wherein at least one prompt of the one or more prompts is related to one or more operations of at least one asset and the profitability of the plant.

8. A system for optimizing asset management in a plant, the system comprising:
a processor;
a memory communicatively coupled to the processor, wherein the memory comprises one or more instructions which when executed by the processor, cause the processor to:
determine impact value data for an intermediate physical stream of a plurality of physical streams of the plant, wherein the impact value data is associated with profitability of the plant;
provide a plurality of predictions for one or more assets from a plurality of assets in the plant, wherein at least one prediction is related to an anomaly of an asset of the one or more assets;
assess impact of each of the plurality of predictions on the profitability of the plant based at least on the impact value data;
prioritize one or more predictions from the plurality of predictions based on the impact assessed for each of the plurality of predictions;
generate one or more recommendations for each of the one or more prioritized predictions; and
render, via a user interface, the one or more recommendations generated for each of the one or more prioritized predictions.

9. The system of claim 8, wherein the processor is further configured to:
obtain details of the intermediate physical stream along with the one or more assets from a corresponding flow sheet model; and
determine input impact value data and output impact value data based on the obtained details, wherein the input impact value data represents a first value associated with one or more first intermediate products received into the intermediate physical stream from at least one upstream pathway, and wherein the output impact value data represents a second value associated with one or more second intermediate products outputted from the intermediate physical stream to at least one downstream pathway.

10. The system of claim 8, wherein the processor is further configured to identify one or more faults in the one or more assets using at least one of one or more predefined rules and one or more algorithms.

11. The system of claim 8, wherein the processor is further configured to:
identify if at least one asset impedes the profitability of the plant and normal operations of the plant; and
determine one or more constraints of the at least one asset which impedes the profitability of the plant and normal operations of the plant.

12. The system of claim 8, wherein the processor is further configured to generate one or more corrective actions based on the impact value data.

13. The system of claim 8, wherein the processor is further configured to present the one or more recommendations via the user interface as a heat map.

14. The system of claim 8, wherein the processor is further configured to receive one or more prompts via the user interface from a user associated with the plant, wherein at least one prompt of the one or more prompts is related to one or more operations of at least one asset and the profitability of the plant.

15. A non-transitory, computer-readable storage medium having stored thereon executable instructions that, when executed by one or more processors, cause the one or more processors to:
determine impact value data for an intermediate physical stream of a plurality of physical streams of the plant, wherein the impact value data is associated with profitability of the plant;
provide a plurality of predictions for one or more assets from a plurality of assets in the plant, wherein at least one prediction is related to an anomaly of an asset of the one or more assets;
assess impact of each of the plurality of predictions on the profitability of the plant based at least on the impact value data;
prioritize one or more predictions from the plurality of predictions based on the impact assessed for each of the plurality of predictions;
generate one or more recommendations for each of the one or more prioritized predictions; and
render, via a user interface, the one or more recommendations generated for each of the one or more prioritized predictions.

16. The non-transitory, computer-readable storage medium of claim 15, wherein the one or more processors is further configured to:
obtain details of the intermediate physical stream along with the one or more assets from a corresponding flow sheet model; and
determine input impact value data and output impact value data based on the obtained details, wherein the input impact value data represents a first value associated with one or more first intermediate products received into the intermediate physical stream from at least one upstream pathway, and wherein the output impact value data represents a second value associated with one or more second intermediate products outputted from the intermediate physical stream to at least one downstream pathway.

17. The non-transitory, computer-readable storage medium of claim 15, wherein the one or more processors is further configured to identify one or more faults in the one or more assets using at least one of one or more predefined rules and one or more algorithms.

18. The non-transitory, computer-readable storage medium of claim 15, wherein the one or more processors is further configured to:
identify if at least one asset impedes the profitability of the plant and normal operations of the plant; and
determine one or more constraints of the at least one asset which impedes the profitability of the plant and normal operations of the plant.

19. The non-transitory, computer-readable storage medium of claim 15, wherein the one or more processors is further configured to generate one or more corrective actions based on the impact value data.

20. The non-transitory, computer-readable storage medium of claim 15, wherein the one or more processors is further configured to present the one or more recommendations via the user interface as a heat map.
